(19) United States
(12) Patent Application Publication
(10) Pub. No.: US 2019/0342173 A1
(43) Pub. Date: Nov. 7, 2019

(54) AUTOMATED NETWORK HOST GROUPING

(71) Applicant: Cisco Technology, Inc., San Jose, CA (US)

(72) Inventors: Laurent Navarro, Paris (FR); Jeffrey Markey, Sterling, VA (US); Matthew Robertson, Santa Clara, CA (US); Sunil Amin, Atlanta, GA (US); Marc Dupont, Boulogne-Billancourt (FR); Timothy Deeb-Swihart, II, Atlanta, GA (US)

(21) Appl. No.: 15/969,462

(22) Filed: May 2, 2018

(51) Int. Cl. H04L 12/24; H04L 12/851; H04L 29/06

(52) U.S. Cl. CPC H04L 41/0893; H04L 41/0286; H04L 41/12; H04L 63/20; H04L 63/0263; H04L 63/104; H04L 47/2483

(57) ABSTRACT

In one example embodiment, a server obtains network flow metadata of a network flow of a host in a network. The server identifies one or more attributes of the network flow metadata. For each host group of a plurality of host groups, the server determines whether the one or more attributes of the network flow metadata satisfy one or more criteria for the host group. For each host group for which it is determined that the one or more attributes of the network flow metadata satisfy the one or more criteria, the server classifies the host as belonging to the host group.

### TECHNICAL FIELD

The present disclosure relates to maintaining security of computer networks.

### BACKGROUND

Computer networks often include entities called network hosts. A network host may provide resources (e.g., services or applications) to users/devices of the computer network. Network hosts may belong to host groups, which are collections of network hosts having common attributes. A security policy for a network host may be enforced based on the host group to which that network host belongs. For example, network hosts in a first host group may be prohibited from communicating with network hosts in a second host group.

### BRIEF DESCRIPTION OF THE DRAWINGS

FIG. 1 illustrates a system including a classifier server configured for automated network host grouping, according to an example embodiment.

FIG. 2 illustrates functional components of the classifier server, according to an example embodiment.

FIG. 3 is a diagram depicting how the classifier server classifies a network host, according to an example embodiment.

FIG. 4 is a block diagram of the classifier server configured to execute automated network host grouping techniques, according to an example embodiment.

FIG. 5 is a flowchart of a method for automated network host grouping, according to an example embodiment.

### DESCRIPTION OF EXAMPLE EMBODIMENTS

### Overview

In one example embodiment, a server obtains network flow metadata of a network flow of a host in a network. The server identifies one or more attributes of the network flow metadata. For each host group of a plurality of host groups, the server determines whether the one or more attributes of the network flow metadata satisfy one or more criteria for the host group. For each host group for which it is determined that the one or more attributes of the network flow metadata satisfy the one or more criteria, the server classifies the host as belonging to the host group.

### EXAMPLE EMBODIMENTS

A “network host” is an entity in a computer network identified by one or more defining attributes in that network. For example, in an Information Technology (IT) network, the Internet Protocol version 4 (IPv4) address or Internet Protocol version 6 (IPv6) address of a host may be a defining attribute which permits identification of that host. Once identified, the host may be classified into one or more network host groups and access on behalf of the host to network resources may be controlled by one or more security policies.

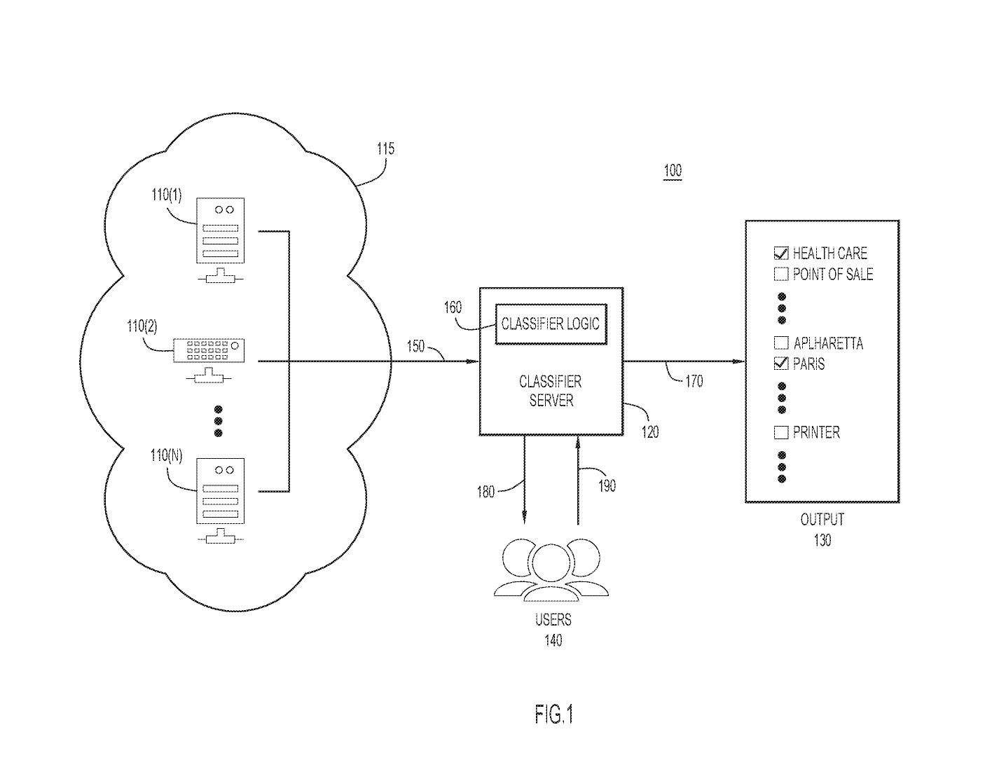

FIG. 1 illustrates a system 100 configured for automated network host grouping. The system 100 includes a plurality of network hosts 110(1)-110(N) on a network 115, a classifier server 120, and classifier output 130 of the classifier server 120. Also shown are users 140, which may interact with classifier server 120 as described below.

The plurality of network hosts 110(1)-110(N) inter-communicate by sending and receiving network flows in network 115. In one example, network flow metadata of these network flows is extracted in the form of flow logs (e.g., NetFlow, hostname data, etc.). At 150, classifier server 120 obtains this network flow metadata, and identifies one or more attributes of the network flow metadata.

Conventional intrusion prevention and detection systems have a signature-based methodology. These conventional systems search for a signature of a network flow, and classify the corresponding network traffic with only a single host group. In other words, current approaches do not permit classifying a single network host in multiple host groups simultaneously.

Accordingly, classifier server 120 includes classifier logic 160, which enables the classifier server 120 to perform multiple classifications in parallel. Unlike conventional approaches, this allows a given network host to be classified into multiple host groups simultaneously.

In particular, for each host group of a plurality of host groups, classifier server 120 determines whether the one or more attributes of the network flow metadata satisfy one or more criteria for the host group. Examples of host groups include: the system to which the network host belongs (e.g., health care system, point of sale system, etc.), the geolocation of the network host (e.g., Alpharetta, Paris, etc.), and the type/function of the network host (e.g., printer, etc.). A host group may include zero or more network hosts.

At 170, for each host group for which it is determined that the one or more attributes of the network flow metadata satisfy the one or more criteria, classifier server 120 classifies the host as belonging to the host group. For example, as shown in classifier output 130, classifier server 120 classifies one of the plurality of network hosts 110(1)-110(N) as belonging to a health care system and as being located in Paris.

Classifier server 120 may determine that the one or more attributes of the network flow metadata satisfy the one or more criteria for each host group of the plurality of host groups (e.g., the “health care” and “Paris” host groups). A conventional system would be unable to satisfy one or more criteria for each host group of the plurality of host groups because such systems cannot classify a single network host in multiple host groups simultaneously.

Moreover, conventional analytics systems require the definition of a host group and associated network hosts to be fed into that system in order for a threat or host group violation to be detected. This definition of a host group (and associated network hosts) is relative to the environment in which the security analytics or threat detection system is deployed. Such systems require domain or deployment specific knowledge to increase the efficacy or relevance of the detection. The burden of creating these host groups, and the associated network hosts members, often falls upon the users of these systems. Creating a meaningful (e.g., deployment/contextual aware) definition of an entity is a significant challenge in deploying and operationalizing security analytics systems.

In view of such challenges, each of the host groups shown in classifier output 130 includes an identifying name (e.g., “health care,” “point of sale,” etc.) that serves as a contextual classification identifier. These identifying names may reflect one or more contextual attributes of the network flow metadata. The contextual attributes may include information about a network host that permits classifier server 120 to classify that network host. One example of a contextual attribute is an IP address that is shared by common peer network hosts. In this example, the IP address of the network host may inform classifier server 120 as to whether that network host should be classified as belonging to a host group based on its relationship to its peer network hosts.

Further, as shown at 180, the classifier server 120 may solicit feedback (e.g., expert knowledge) from one or more users 140, and at 190, may obtain the feedback. This feedback may help the classifier server 120 to identify a contextual classification of the plurality of network hosts 110(1)-110(N) in the network 115.

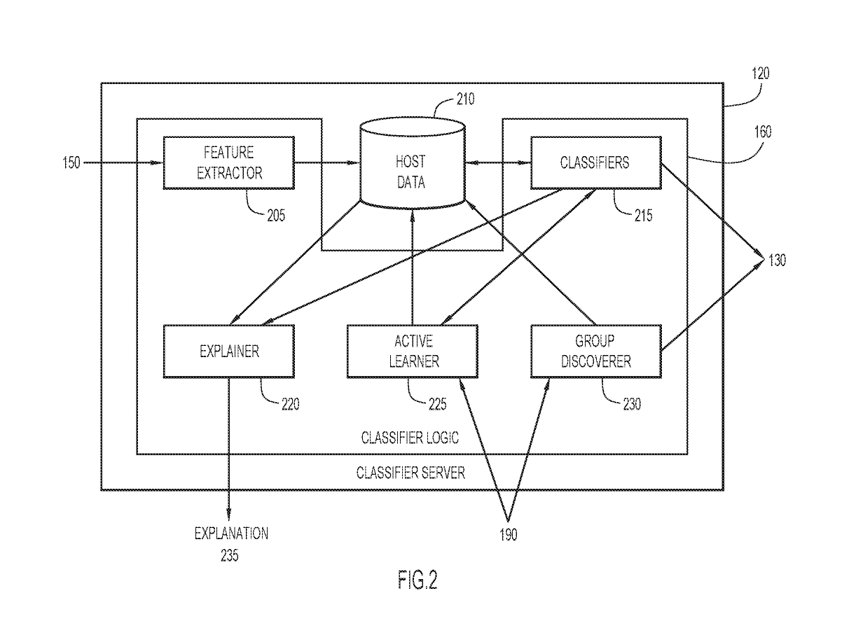

FIG. 2 illustrates the internal architecture and communication flows of classifier server 120. Classifier server 120 includes several functional components, including feature extractor 205, host data 210, classifiers 215, explainer 220, active learner 225, and group discoverer 230. Feature extractor 205, classifiers 215, explainer 220, active learner 225, and group discoverer 230 may be logical features/functions of classifier logic 160. In this example, host data 210 is a repository that centralizes respective inputs and outputs of feature extractor 205, classifiers 215, explainer 220, active learner 225, and group discoverer 230.

As shown at 150, feature extractor 205 obtains and transforms network flow metadata to determine characteristics of the network host. These characteristics are used to determine to which host groups (if any) a network host should be classified. Feature extractor 205 may store the network flow metadata as host data 210. Host data 210 may comprise a database or repository to store the network flow metadata/attributes.

Classifiers 215 may assign labels to a network host based on the extracted features of the network host (e.g., the network flow metadata/attributes stored as host data 210). The labels may correspond to host groups. In one example, classifiers 215 may be subject to user input. For instance, a user (e.g., one of users 140) may dynamically add/remove host groups. Users 140 may create a given host group at any time. The classification rules need not be fixed, and may be user-specific.

When classifiers 215 classify network hosts into host groups, explainer 220 may cause classification decisions to be displayed (e.g., as output 130) to the user as a list of possible host groups. If the list consists of IP addresses or host names, it can be difficult for the user to make the decision without additional investigation of the behavior of the network hosts. Accordingly, explainer 220 may provide a detailed explanation 235 (e.g., for users 140) of the classification decisions made by classifiers 215. Explanation 235 may comprise a solicitation of feedback as shown at 180 (FIG. 1).

Thus, in one example, for the host groups for which it is determined that the one or more attributes of the network flow metadata satisfy the one or more criteria, the classifier server 120 may generate for presentation to a user an explanation as to why the host is being classified as belonging to those host groups.

Explainer 220 may present the classifiers 215 to the user as white-boxes or black-boxes. For white-box classifiers, with models such as linear/logistic regressions or decision trees, the weight of each host group may be computed into the decision. The most significant host group(s) may be displayed for user validation or rejection. For black-box classifiers, a specific approach may be used to explain the decision. Conventional models typically use a white-box model to make a local approximation of the black-box model in the neighborhood of the data point that needs explanation.

Active learner 225 helps capture knowledge from users 140 in order to improve the speed and accuracy of classifiers 215. If the classifiers 215 only have a few data points from which to learn, the classifiers 215 may require more data to reinforce their model(s). Conventional approaches involve waiting for a user to parse many recommendations and validate or reject them. This has a low convergence rate because classifiers can already have a high confidence for the network hosts for which they request recommendations.

As such, one improved option is to sample a small number of network hosts which, if the user provides feedback, optimizes the information needed to refine the classifiers 215. For instance, it is possible to choose the unclassified network hosts that are the closest to the decision boundary, and thus have the maximum information entropy. Labelling those network hosts provides a higher probability to refine the decision boundary and thus improve the model. Many policies are possible, some of which depend on the classification approach used. In any case, this sampling helps to select a very small number of network hosts (e.g., one, two, etc.) to be displayed to the user, in order to help calibrate the classifiers 215. Labelling those network hosts is not mandatory, but after the creation of the host group such labelling may improve the recommendations.

Thus, in one example, for the host groups for which it is determined that the one or more attributes of the network flow metadata satisfy the one or more criteria, classifier sever 120 may solicit feedback from a user as to whether the host is accurately classified as belonging to the host groups for which it is determined that the one or more attributes of the network flow metadata satisfy the one or more criteria. The classifier server 120 obtains the feedback and, based on the feedback, modifies how it is determined that the one or more attributes of the network flow metadata satisfy the one or more criteria

One goal of the classifiers 215 is to enable providing a recommendation, to the user, of a set of network hosts for each previously defined network host. However, these recommendations may not necessarily be for the purpose of creating host groups. Rather, this task is devoted to the group discoverer 230, which provides a simple way for a user to analyze the network and determine which host groups are relevant. Several approaches may be used simultaneously, including rule-based, clustering, and user-defined group approaches.

The rule-based approach involves predefined rules (e.g., rules defined by a service provider) to identify, e.g., Domain Name System (DNS) servers, web servers, domain servers, and other well-defined groups. Thus, classifier server 120 may determine whether the one or more attributes of the network flow metadata satisfy one or more criteria for the host group based on a predefined rule that specifies the one or more criteria for a particular host group of the plurality of host groups. For example, the user may write simple rules, based on user knowledge of the network, such as grouping hosts based on IP subnets or communication protocols. In one example, unless a rule is determined to be incorrect by active learner 225, it is used for labelling. When the rule is contradicted, it is discarded. A classifier may be instantiated in place of the rule.

The clustering approach involves unsupervised learning based on network flow metadata to identify network hosts that behave similarly. In one example, classifier server 120 may identify a first new attribute of the network flow metadata and a second new attribute of the network flow metadata based on a similarity distance between the first new attribute and the second new attribute. In response to identifying the first new attribute and the second new attribute, the classifier server 120 may define a new host group having one or more criteria satisfied by the first new attribute and the second new attribute. The clustering approach may involve analyzing the network using predefined libraries of similarity distances applied to subsets of network flow metadata to determine which hosts share a common behavior and might be grouped together. Unlike the rules in the rule-based approach that may be used as classifiers 215 until proven wrong, the clusters help fill host groups with as many relevant network hosts as possible. These clusters may be refined later by the classifiers 215.

The user-defined group approach uses network administrator defined rules. For example, if a user has very specific groups in mind, neither the rule-based approach nor the clustering approach may provide an adequate solution. In this case, the user may create network groups manually and allocate network hosts to the network groups. If there is a sufficient number of hosts, classifiers 215 may be instantiated and help refine the groups, similar to groups created via clustering.

Whichever approach is selected, the newly created host groups may act as a bootstrap for the classifiers 215, whose task is to refine those host groups. Consequently, it is helpful for a host group to be as homogeneous as possible. That is, the network hosts classified as belonging to a given host group should actually belong to that host group. This helps the classifiers 215 converge as quickly as possible to a high accuracy score. The more hosts allocated initially, the better the classifiers 215 will operate. Moreover, active learner 225 may be useful for small host groups that have been discovered by the group discoverer 230, and for which a classifier has been instantiated. The explainer 220 may also be used to explain the newly created host groups via clustering by the group discoverer 230, in order to help the user validate or reject the proposed host groups.

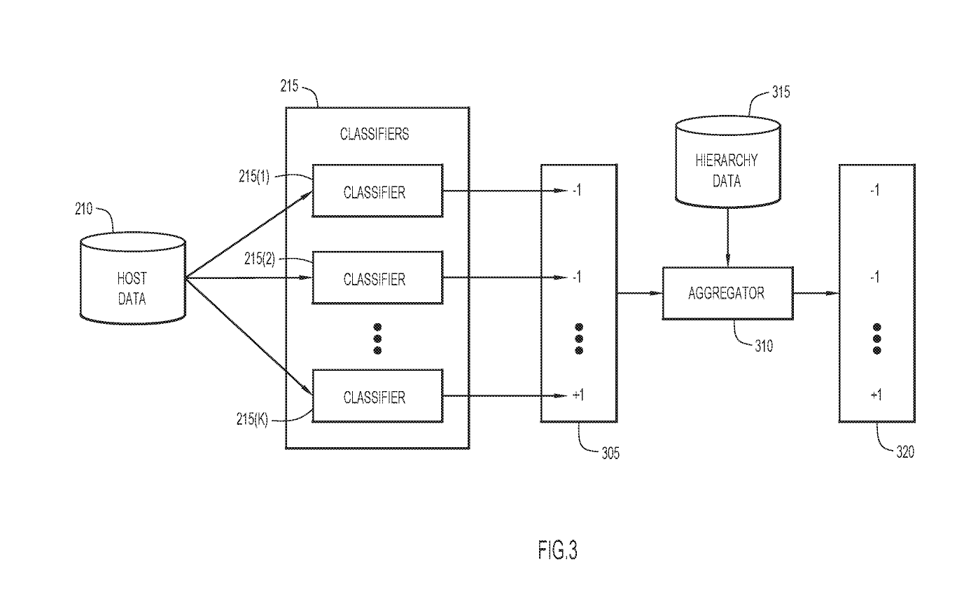

FIG. 3 illustrates how the classifier server 120 classifies a network host using classifiers 215. As shown, classifiers 215(1)-215(K) analyze the network flow metadata from host data 210 to match specified or learned criteria. At 305, each classifier 215(1)-215(K) may independently output a match (+1) or mismatch (−1). For example, the classifiers 215(1)-215(K) may determine that the one or more attributes of the network flow metadata satisfy the one or more criteria for each host group of the plurality of host groups.

The outputs of the independent classifiers 215(1)-215(K) may be input into aggregator 310. The aggregator 310 obtains, from hierarchy data 315, a predetermined hierarchical structure of the network hosts 110(1)-110(N). Based on the hierarchy data 315, the aggregator 310 may determine whether the classification outputs (i.e., +/−1) from the classifiers 215(1)-215(N) matches the predetermined hierarchical structure.

At 320, the aggregator 310 outputs a classification (i.e., host group membership for the host network) and its determination by the classifier to that group (+1) or (−1). The aggregator 310 may enforce the consistency between the output of the classifiers 215(1)-215(N) and the hierarchy data 315 by applying different policies. This may occur during the learning phase or at run-time (e.g., when new network host is classified, when a new host group is created, periodically, etc.). The classifiers 215(1)-215(N) may be open and flexible, and able to classify a single network host into a category based on any combination of network attributes, behavior, or content delivered to/stored in the host data 210.

In one example, the classifier server 120 may determine that the one or more attributes of the network flow metadata satisfy the one or more criteria for each host group of the plurality of host groups. Since a network host may be classified as belonging to multiple host group simultaneously, classification rules may cover different aspects of a network. As such, different host groups may be created based on these aspects (e.g., geographical location(s) of the host or services offered). Consequently, an approach involving multiple binary classifiers may be used instead of, e.g., a conventional single multi-label classifier. Each classifier may be associated with a specific host group, and a new host group may be added by instantiating a new classifier.

A hierarchical structure may be associated with the host groups. For example, the hierarchy may include the host group “DNS servers” as a subset of “System Servers,” or “Paris DNS servers” as a subset of “DNS servers.” If a server (network host) is classified as belonging to the Paris DNS servers host group, for example, that server may also automatically be classified as belonging to the DNS servers host group.

Accordingly, in one example, a plurality of host groups are logically arranged in a hierarchical structure including a subset host group (e.g., “Paris DNS servers”) within a superset host group (e.g., “DNS servers”). The classifier server 120 may classify the host as belonging to the subset host group and, in response, automatically classify the host as also belonging to the superset host group. In another example, the classifier server 120 may classify the host as not belonging to the superset host group and, in response, automatically classifying the host as also not belonging to the subset host group.

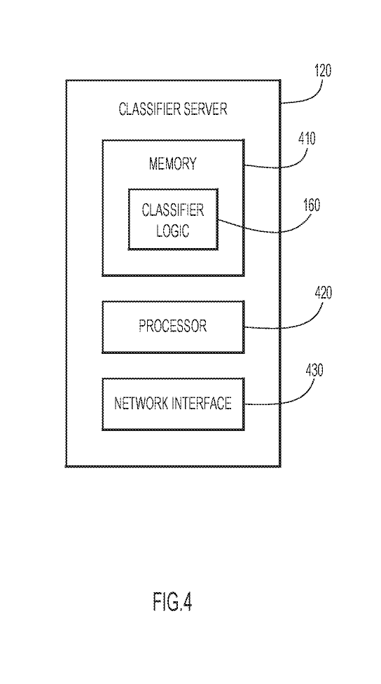

FIG. 4 is a simplified block diagram of a server configured to implement the techniques presented herein (e.g., classifier server 120). In this example, the classifier server 120 includes a memory 410 that stores instructions for classifier logic 160, one or more processors 420, and a network interface 430. The one or more processors 420 are configured to execute instructions stored in the memory 410 for the classifier logic 160. When executed by the one or more processors 420, the classifier logic 160 causes the classifier server 120 to perform operations described herein. The network interface 430 is a network interface card (or multiple instances of such a device) or other network interface device that enables network communications on behalf of the classifier server 120 for sending and receiving messages as described above.

The memory 410 may be read only memory (ROM), random access memory (RAM), magnetic disk storage media devices, optical storage media devices, flash memory devices, electrical, optical, or other physical/tangible memory storage devices. Thus, in general, the memory 410 may be one or more tangible (non-transitory) computer readable storage media (e.g., a memory device) encoded with software comprising computer executable instructions and when the software is executed (by the processor 420) it is operable to perform the operations described herein.

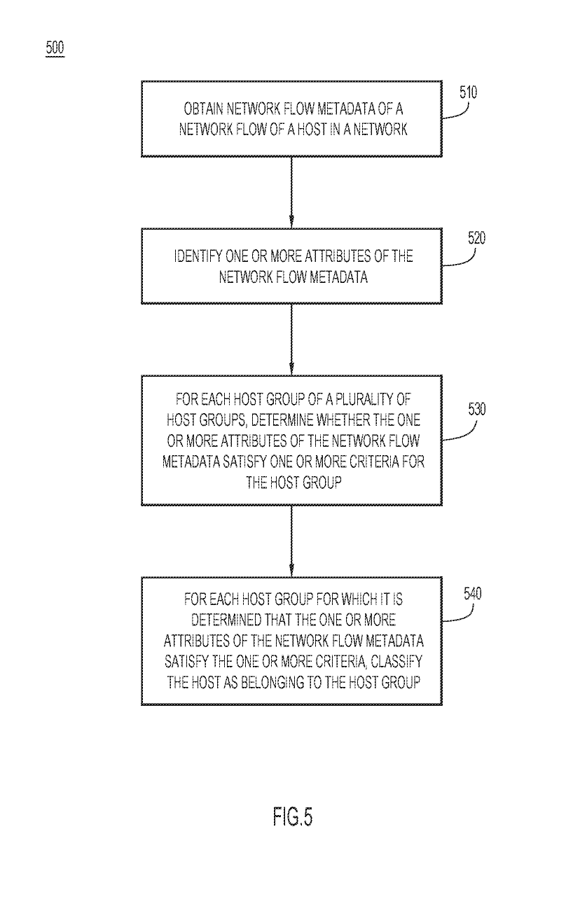

FIG. 5 is a flowchart of a method 500 for automated network host grouping in accordance with examples presented herein. Method 500 may be performed by a server (e.g., classifier server 120). At 510, the server obtains network flow metadata of a network flow of a host in a network. At 520, the server identifies one or more attributes of the network flow metadata. At 530, for each host group of a plurality of host groups, the server determines whether the one or more attributes of the network flow metadata satisfy one or more criteria for the host group. At 540, for each host group for which it is determined that the one or more attributes of the network flow metadata satisfy the one or more criteria, the server classifies the host as belonging to the host group.

Mechanisms are provided to automatically classify network hosts into contextual groups based on the network behavior of the network hosts. User feedback may be leveraged to capture deployment specific information, thereby facilitating the discovery of network hosts in a computer network. The network hosts may be classified into multiple potential host groups (e.g., system suggested or user created) based on network behavior and contextual attributes. The host group definitions and membership may be output to, for example, a security analytics or threat detection system.

At least one approach involves discovering network hosts based on network metadata, classifying those network hosts into one or more host groups based on network host behavior, and leveraging user feedback to create, refine, or change those classifications. This may be performed while maintaining a hierarchical approach to classification. A transparent feedback mechanism may be provided explaining the classifications.

These techniques enable the automatic discovery, creation, and definition of a set of host groups, and the classification of network hosts that can hold multiple classifications. Those host groups and classifications/network hosts may be provided as an output. The output may be leveraged by various security technologies (e.g., a security analytics system). These classifications may also be provided to other systems, such as a network access control system, firewall, intrusion prevention system, intrusion detection system, anomaly detection system, etc.

A methodology is provided whose inputs comprise network metadata, including both transactional data (e.g., logs from inline devices such as NetFlow) and contextual data (e.g., hostname from reverse DNS lookups, username, and other attributes from an identity store), aggregated over a specified time-lapse. This methodology may output recommendations in the form of lists of network hosts, each tagged as belonging to one or more user defined host groups. The methodology also incorporates user feedback in order to model user expertise and drive the classification, and outputs an explanation for one or more of such classifications.

Mechanisms are described which leverage user feedback to capture deployment specific information, facilitate the discovery of network hosts in a computer network, and classify the network hosts into multiple potential host groups (either system suggested or user created) based on network behavior and contextual attributes. The host groups and memberships/classifications may be output to a security analytics or threat detection system.

In one form, a method is provided. The method comprises: obtaining network flow metadata of a network flow of a host in a network; identifying one or more attributes of the network flow metadata; for each host group of a plurality of host groups, determining whether the one or more attributes of the network flow metadata satisfy one or more criteria for the host group; and for each host group for which it is determined that the one or more attributes of the network flow metadata satisfy the one or more criteria, classifying the host as belonging to the host group.

In another form, an apparatus is provided. The apparatus comprises: a network interface configured to obtain network flow metadata of a network flow of a host in a network; and one or more processors coupled to the network interface, wherein the one or more processors are configured to: identify one or more attributes of the network flow metadata; for each host group of a plurality of host groups, determine whether the one or more attributes of the network flow metadata satisfy one or more criteria for the host group; and for each host group for which it is determined that the one or more attributes of the network flow metadata satisfy the one or more criteria, classify the host as belonging to the host group.

In another form, one or more non-transitory computer readable storage media are provided. The non-transitory computer readable storage media are encoded with instructions that, when executed by a processor of a server, cause the processor to: obtain network flow metadata of a network flow of a host in a network; identify one or more attributes of the network flow metadata; for each host group of a plurality of host groups, determine whether the one or more attributes of the network flow metadata satisfy one or more criteria for the host group; and for each host group for which it is determined that the one or more attributes of the network flow metadata satisfy the one or more criteria, classify the host as belonging to the host group.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining network flow metadata of a network flow of a host in a network;
identifying one or more attributes of the network flow metadata;
for each host group of a plurality of host groups, determining whether the one or more attributes of the network flow metadata satisfy one or more criteria for the host group; and
for each host group for which it is determined that the one or more attributes of the network flow metadata satisfy the one or more criteria, classifying the host as belonging to the host group.

2. The method of claim 1, wherein the plurality of host groups are logically arranged in a hierarchical structure including a subset host group within a superset host group, and wherein:
classifying the host includes classifying the host as belonging to the subset host group, the method further comprising:
in response to classifying the host as belonging to the subset host group, automatically classifying the host as belonging to the superset host group.

3. The method of claim 1, wherein the plurality of host groups are logically arranged in a hierarchical structure including a subset host group within a superset host group, and wherein:
classifying the host includes classifying the host as not belonging to the superset host group, the method further comprising:
in response to classifying the host as not belonging to the superset host group, automatically classifying the host as not belonging to the subset host group.

4. The method of claim 1, wherein:
determining includes determining that the one or more attributes of the network flow metadata satisfy the one or more criteria for each host group of the plurality of host groups.

5. The method of claim 1, wherein determining includes determining based on a predefined rule that specifies the one or more criteria for a particular host group of the plurality of host groups.

6. The method of claim 1, wherein:
identifying the one or more attributes of the network flow metadata includes identifying a first new attribute of the network flow metadata and a second new attribute of the network flow metadata based on a similarity distance between the first new attribute and the second new attribute, the method further comprising:
in response to identifying the first new attribute and the second new attribute, defining a new host group having one or more criteria satisfied by the first new attribute and the second new attribute.

7. The method of claim 1, further comprising:
for the host groups for which it is determined that the one or more attributes of the network flow metadata satisfy the one or more criteria, soliciting feedback from a user as to whether the host is accurately classified as belonging to the host groups for which it is determined that the one or more attributes of the network flow metadata satisfy the one or more criteria;
obtaining the feedback; and
based on the feedback, modifying how it is determined that the one or more attributes of the network flow metadata satisfy the one or more criteria.

8. The method of claim 1, further comprising:
for the host groups for which it is determined that the one or more attributes of the network flow metadata satisfy the one or more criteria, generating for presentation to a user an explanation for the host being classified as belonging to the host groups for which it is determined that the one or more attributes of the network flow metadata satisfy the one or more criteria.

9. An apparatus comprising:
a network interface configured to obtain network flow metadata of a network flow of a host in a network; and
one or more processors coupled to the network interface, wherein the one or more processors are configured to:
identify one or more attributes of the network flow metadata;
for each host group of a plurality of host groups, determine whether the one or more attributes of the network flow metadata satisfy one or more criteria for the host group; and
for each host group for which it is determined that the one or more attributes of the network flow metadata satisfy the one or more criteria, classify the host as belonging to the host group.

10. The apparatus of claim 9, wherein the plurality of host groups are logically arranged in a hierarchical structure including a subset host group within a superset host group, and wherein the one or more processors are configured to:
classify the host by classifying the host as belonging to the subset host group; and
in response to classifying the host as belonging to the subset host group, automatically classify the host as belonging to the superset host group.

11. The apparatus of claim 9, wherein the plurality of host groups are logically arranged in a hierarchical structure including a subset host group within a superset host group, and wherein the one or more processors are configured to:
classify the host by classifying the host as not belonging to the superset host group; and
in response to classifying the host as not belonging to the superset host group, automatically classify the host as not belonging to the subset host group.

12. The apparatus of claim 9, wherein the one or more processors are configured to:
determine that the one or more attributes of the network flow metadata satisfy the one or more criteria for each host group of the plurality of host groups.

13. The apparatus of claim 9, wherein the one or more processors are configured to:
determine based on a predefined rule that specifies the one or more criteria for a particular host group of the plurality of host groups.

14. The apparatus of claim 9, wherein the one or more processors are configured to:
identify the one or more attributes of the network flow metadata by identifying a first new attribute of the network flow metadata and a second new attribute of the network flow metadata based on a similarity distance between the first new attribute and the second new attribute; and
in response to identifying the first new attribute and the second new attribute, define a new host group having one or more criteria satisfied by the first new attribute and the second new attribute.

15. One or more non-transitory computer readable storage media encoded with instructions that, when executed by a processor of a server, cause the processor to:
obtain network flow metadata of a network flow of a host in a network;
identify one or more attributes of the network flow metadata;
for each host group of a plurality of host groups, determine whether the one or more attributes of the network flow metadata satisfy one or more criteria for the host group; and
for each host group for which it is determined that the one or more attributes of the network flow metadata satisfy the one or more criteria, classify the host as belonging to the host group.

16. The non-transitory computer readable storage media of claim 15, wherein the plurality of host groups are logically arranged in a hierarchical structure including a subset host group within a superset host group, and wherein the instructions cause the processor to:
classify the host by classifying the host as belonging to the subset host group; and
in response to classifying the host as belonging to the subset host group, automatically classify the host as belonging to the superset host group.

17. The non-transitory computer readable storage media of claim 15, wherein the plurality of host groups are logically arranged in a hierarchical structure including a subset host group within a superset host group, and wherein the instructions cause the processor to:
classify the host by classifying the host as not belonging to the superset host group; and
in response to classifying the host as not belonging to the superset host group, automatically classify the host as not belonging to the subset host group.

18. The non-transitory computer readable storage media of claim 15, wherein the instructions cause the processor to:
determine that the one or more attributes of the network flow metadata satisfy the one or more criteria for each host group of the plurality of host groups.

19. The non-transitory computer readable storage media of claim 15, wherein the instructions cause the processor to:
determine based on a predefined rule that specifies the one or more criteria for a particular host group of the plurality of host groups.

20. The non-transitory computer readable storage media of claim 15, wherein the instructions cause the processor to:
identify the one or more attributes of the network flow metadata by identifying a first new attribute of the network flow metadata and a second new attribute of the network flow metadata based on a similarity distance between the first new attribute and the second new attribute; and
in response to identifying the first new attribute and the second new attribute, define a new host group having one or more criteria satisfied by the first new attribute and the second new attribute.
